(19) United States
(12) Patent Application Publication
(10) Pub. No.: US 2009/0185559 A1
(43) Pub. Date: Jul. 23, 2009

(54) INTEGRATION MODULE FOR UNIVERSAL SERIAL BUS

(76) Inventors: Evan CHEN, Taipei (TW); Ching-Lung Cheng, Taipei (TW)

Correspondence Address: Joe McKinney Muncy, PO Box 1364, Fairfax, VA, 22038-1364, US

(21) Appl. No.: 12/016,873

(22) Filed: Jan. 18, 2008

(51) Int. Cl. H04L 12/50; H04Q 11/00

(52) U.S. Cl. 370/362

(57) ABSTRACT

An integration module for universal serial bus installed on an electronic equipment includes an integration unit electrically coupled on at least one transmission interface of the electronic equipment to be driven by a host-to-host control unit to enter a host-to-host transmission mode or a host-to-device control unit to enter a host-to-device transmission mode. The integration unit has a switch mechanism to determine whether the transmission interface to become the host-to-host transmission mode or the host-to-device transmission mode. Through the switch mechanism of the integration unit, a single transmission interface can selectively transmit data between hosts or between a host and devices.

### FIELD OF THE INVENTION

The present invention relates to an integration module for universal serial bus (USB) and particularly to a USB integration module to selectively provide a host-to-host transmission mode or a host-to-device transmission mode.

### BACKGROUND OF THE INVENTION

USB basically is a transmission standard to perform data transmission between a master and a slave device. Its most notable characteristic is simplifying I/O of slave devices without the need of providing a plurality of corresponding architectures for connecting different slave devices to a host that occurred to the traditional techniques in the past. In addition, USB also provides Hot plug and Plug-and-Play features that make connection much easier. Compared with other bus connection methods such as IEEE 1394, the price of USB is lower, and compatibility of USB also is greater such that it is adaptable to a wide variety of computer devices, thus it is widely accepted.

In the earlier days USB had limited transmission speed (maximum 12 Mbps), hence it was mostly used on low speed transmission devices such as human interface devices (HIDs) like keyboards, mouse and the like. It takes a longer time to transmit a great amount of data. Transmission reliability also is not desirable. However, with introducing of USB 2.0 transmission bandwidth is increased to 480 Mbps. The problem of low speed transmission in the past is overcome. It can compete with IEEE 1394 in terms of transmission speed. Thus it is gradually being used to transmit large volume of information. But as USB was originally being defined as the connection interface between a computer host and peripheral devices, the basic architecture adopts a Tiered-star topology with a host as the transmission center. All the transmission has to conform to a master-slave connection relationship. Such a design limits USB application scope and makes universal point-to-point connection not possible, such as transmission among the peripheral devices, or between hosts. To facilitate direct transmission between the lower power peripheral devices without relying on the host, an OTG (On-The-Go) protocol has been developed on the USB 2.0 architecture. Reference of USB devices conforming to the OTG protocol can be found in U.S. Pat. No. 7,214,089 and 20060195625.

Due to the storage capacity of hard disks increases greatly, to perform data transmission between computer hosts through an indirect means such as on optical disk, MO or other media, multiple transmissions have to be adopted due to capacity constraint of the storage media. In the event that to do data transmission through a local area network is desired, a network adapter card has to be added to the computer host, or a network line has to be installed. All this hinders utilization. A technique to connect hosts through USB has been developed, such as U.S. Pat. No. 7,162,588 which connects USB ports of two hosts through a USB bridge connector to transmit information between the two hosts. However, such a linking approach can only transmit data between two hosts, but cannot transmit data between the host and devices. As the host has merely a small number of USB ports, the number of connectable devices also is limited. While a single host can be connected to maximum 127 devices through a hub, it shares the connection through a single port. As a result the bandwidth and power supply of the devices at the farther end of the downstream become increasingly unstable. Hence there are still rooms for improvement in terms of deploying a plurality of USB devices.

### SUMMARY OF THE INVENTION

The primary object of the present invention is to allow a single universal transmission interface to selectively switch between host-to-host transmission and host-to-device transmission. To achieve the foregoing object, the invention provides an integration module for USB to be installed on an electronic equipment. It includes an integration unit, a host-to-host control unit and a host-to-device control unit that are connected to the integration unit. The integration unit provides a host-to-host transmission mode and a host-to-device transmission mode. The integration unit also is electrically coupled with at least one transmission interface located on the electronic equipment. The host-to-host control unit generates a first signal to drive the integration unit to enter the host-to-host transmission mode. The host-to-device control unit generates a second signal to drive the integration unit to enter the host-to-device transmission mode. The integration unit has a switch mechanism to determine whether to receive the first signal or the second signal to make the transmission interface to become the host-to-host transmission mode or the host-to-device transmission mode.

In one embodiment of the invention, the switch mechanism has an ON/OFF unit connecting to the host-to-host control unit. The ON/OFF unit controls the host-to-host control unit whether to send the first signal to the integration unit.

In another embodiment of the invention, the switch mechanism has an ON/OFF unit connecting to the host-to-device control unit. The ON/OFF unit controls the host-to-device control unit whether to send the second signal to the integration unit.

In yet another embodiment the switch mechanism has a switch unit bridging the host-to-host control unit and the host-to-device control unit to switch between them and determine whether to send the first signal or the second signal to the integration unit.

The integration module of the invention can selectively switch between the host-to-host transmission mode and the host-to-device transmission mode so that one single transmission interface can perform a selected function according to different requirements to fully utilize the limited transmission interface on the host. There is no need to install transmission interfaces of different functions in response to different transmission modes. Space utilization of the host also can be improved.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a circuit block diagram of a first embodiment of the integration module for USB of the invention.

FIG. 2 is a circuit block diagram of a second embodiment of the integration module for USB of the invention.

FIG. 3 is a circuit block diagram of a third embodiment of the integration module for USB of the invention.

### DETAILED DESCRIPTION OF THE PREFERRED EMBODIMENTS

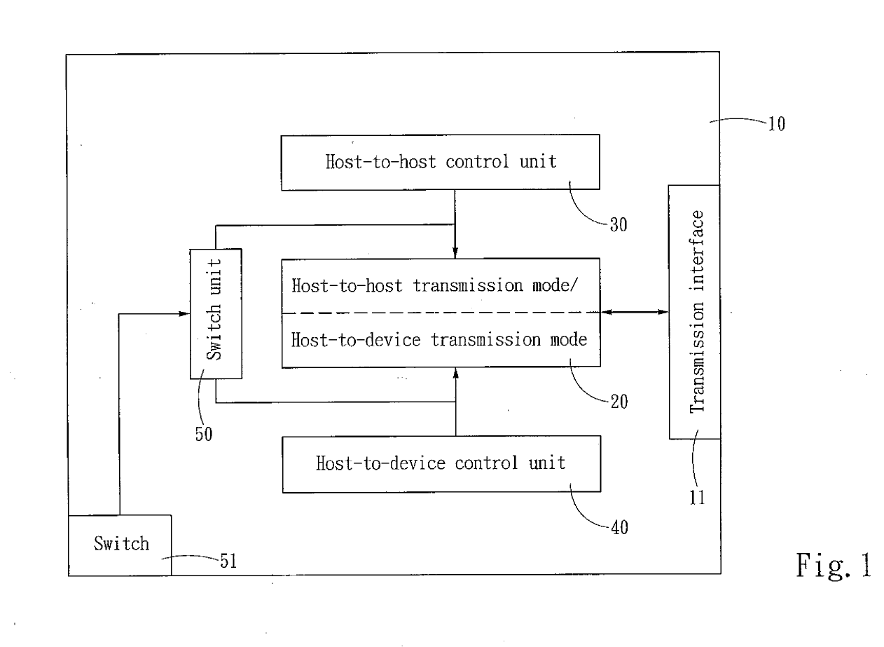

Please refer to FIG. 1 for the circuit block diagram of a first embodiment of the invention. The integration module for USB of the invention aims to be installed in an electronic equipment (such as a personal computer or hub or the like) 10. It includes an integration unit 20 electrically coupled on at least one transmission interface 11 of the electronic equipment 10. The integration unit 20 provides a host-to-host transmission mode and a host-to-device transmission mode. The host-to-host transmission mode aims to transmit signals between two sets of the electronic equipments 10 equipped with high information processing power such as personal computers. The host-to-device transmission mode is the transmission mode of the ordinary USB, namely provides transmission between one electronic equipment 10 equipped with high information processing power (such as a personal computer) and a device of a lower power (such as a keyboard, generally called a device), or between the electronic equipment 10 equipped with high information processing power and a plurality of devices through a connecting hub. The devices can be human interface devices such as mice, keyboards, and the like, or data storage devices such as flash disks, external hard disks, or other lower power devices connecting to the computer host through the USB interface.

The integration unit 20 is electrically connected to a host-to-host control unit 30 and a host-to-device control unit 40. The host-to-host control unit 30 generates a first signal to drive the integration unit 20 to enter the host-to-host transmission mode. The host-to-device control unit 40 generates a second signal to drive the integration unit 20 to enter the host-to-device transmission mode. Namely the integration unit 20, based on whether the electronic equipment 10 is connected to another host or device, selectively executes the host-to-host transmission mode through the host-to-host control unit 30, or host-to-device transmission mode through the host-to-device control unit 40.

The integration unit 20 also has a switch mechanism to determine whether to receive the first signal from the host-to-host control unit 30 or the second signal from the host-to-device control unit 40 to make the transmission interface to become the host-to-host transmission mode or the host-to-device transmission mode. The general USB, aside from performing data transmission, also receives electric power from a motherboard. In the invention the transmission interface 11 can be selected to transmit the signal independently, or the signal and power at the same time. These are embodiment options of the invention but not the limitation thereof.

In the embodiment set forth above, the switch mechanism has a switch unit 50 bridging the host-to-host control unit 30 and the host-to-device unit 40. The switch unit 50 may be connected to a switch 51 to control the switch unit 50. The switch unit 50 outputs a switch signal to the host-to-host control unit 30 and the host-to-device unit 40 to determine whether the integration unit 20 to receive the first signal from the host-to-host control unit 30 and the second signal from the host-to-device unit 40, then the transmission interface 11 is ordered in the host-to-host transmission mode or the host-to-device transmission mode. Through a corresponding transmission equipment such as a USB transmission line, data transmission can be performed with another host or device.

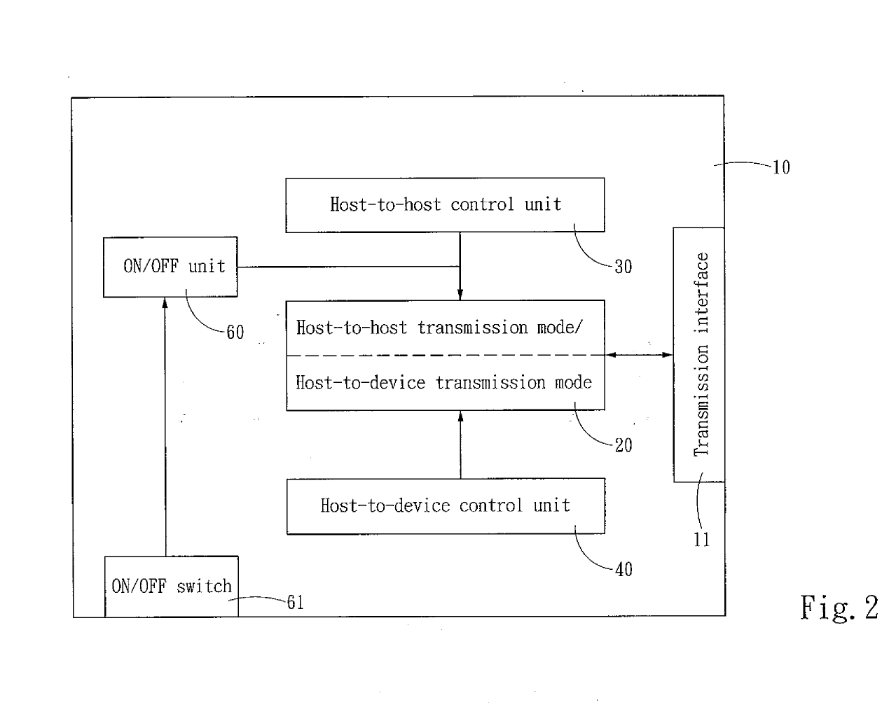

Refer to FIG. 2 for the circuit block diagram of a second embodiment of the invention. It differs from the first embodiment by having the host-to-host control unit 30 connecting to an ON/OFF unit 60 which is also connected to an ON/OFF switch 61. When making the integration unit 20 to enter the host-to-device transmission mode is desired, users can control the ON/OFF unit 60 through the ON/OFF switch 61 to output an OFF signal to the host-to-host control unit 30 to stop sending the first signal to the integration unit 20. Meanwhile the integration unit 20 receives only the second signal generated by the host-to-device control unit 40 to make the integration unit 20 to enter the host-to-device transmission mode. By contrast, in the event that the ON/OFF unit 60 stops sending the ON/OFF signal to the host-to-host control unit 30, the integration unit 20 receives the first signal from the host-to-host control unit 30 at a higher priority so that the integration unit 20 orders the transmission interface 11 to become the host-to-host transmission mode.

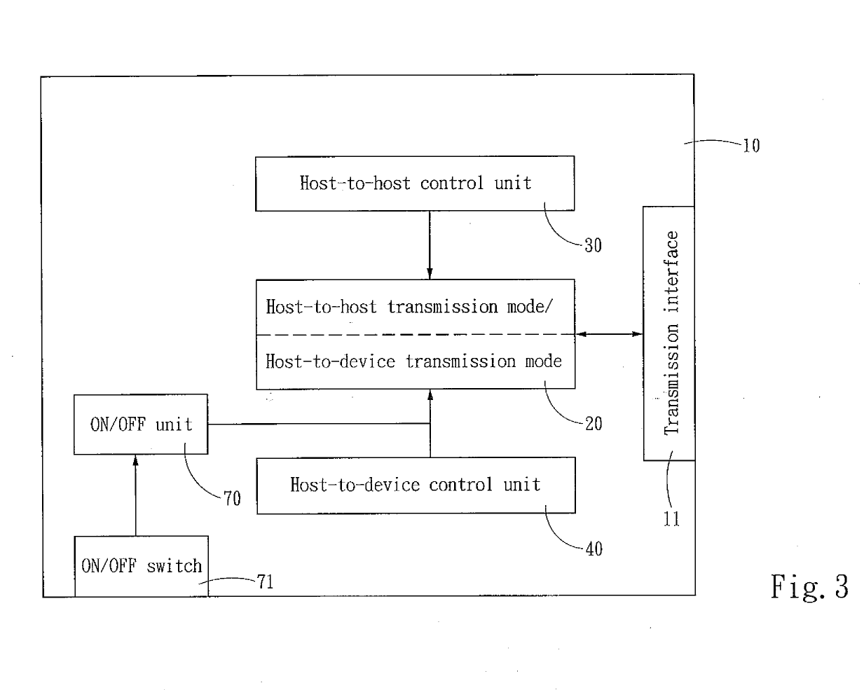

Refer to FIG. 3 for a third embodiment of the invention. The switch mechanism has an ON/OFF unit 70 connecting to the host-to-device control unit 40 and an ON/OFF switch 71. In this embodiment making the integration unit 20 to enter the host-to-host transmission mode can be accomplished through the ON/OFF switch 71 by generating an OFF signal to the host-to-device control unit 40 to stop sending the second signal to the integration unit 20. Hence the integration unit 20 receives only the first signal from the host-to-host control unit 30, and be driven to enter the host-to-host transmission mode. By contrast, making the integration unit 20 to enter the host-to-device transmission mode through the transmission interface 11 can be accomplished by regulating the ON/OFF unit 70 through the ON/OFF switch 71 to stop sending the OFF signal to the host-to-device control unit 40. Then the integration unit 20 receives the second signal from the host-to-device control unit 40 at a higher priority so that the integration unit 20 is driven to enter the host-to-device transmission mode.

Thus the switch mechanism of the integration unit 20 may include a switch unit 50 between the host-to-host control unit 30 and the host-to-device control unit 40 to switch the integration unit 20 to receive the first signal or the second signal. Or the host-to-host control unit 30 or the host-to-device control unit 40 may be connected to the ON/OFF unit 60 or 70 to stop output of the first signal or the second signal to control the integration unit 20 to enter the host-to-host transmission mode or the host-to-device mode through the transmission interface 11.

As a conclusion, the integration module of the invention has an integration unit 20 located in an electronic equipment 10 equipped with a USB that has a switch mechanism to allow the integration unit 20 to selectively enter the host-to-host transmission mode or the host-to-device transmission mode so that the integration unit 20 can transmit data with another host or device through at least one transmission interface 11. Compared with the traditional USB which has one transmission interface 11 to provide merely one function, the invention provides a switch mechanism to increase use flexibility of the transmission interface 11 so that the electronic equipment 10 equipped with a limited transmission interface 11 can be more efficiently connected to other devices. It provides a significant improvement over the conventional techniques.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An integration module for universal serial bus to be installed on an electronic equipment, comprising:
an integration unit which has a host-to-host transmission mode and a host-to-device transmission mode and is electrically coupled to at least one transmission interface of the electronic equipment; and
a host-to-host control unit to generate a first signal to drive the integration unit to enter the host-to-host transmission mode and a host-to-device control unit to generate a second signal to drive the integration unit to enter the host-to-device transmission mode;
wherein the integration unit has a switch mechanism to determine whether to receive the first signal or the second signal to make the transmission interface to become the host-to-host transmission mode or the host-to-device transmission mode.

2. The integration module for universal serial bus of claim 1, wherein the switch mechanism includes an ON/OFF unit connecting to the host-to-host control unit.

3. The integration module for universal serial bus of claim 2, wherein the ON/OFF unit is connected to an ON/OFF switch.

4. The integration module for universal serial bus of claim 1, wherein the switch mechanism includes an ON/OFF unit connecting to the host-to-device control unit.

5. The integration module for universal serial bus of claim 4, wherein the ON/OFF unit is connected to an ON/OFF switch.

6. The integration module for universal serial bus of claim 1, wherein the switch mechanism includes a switch unit bridging the host-to-host control unit and the host-to-device control unit.

7. The integration module for universal serial bus of claim 6, wherein the switch unit is connected to a switch.

8. The integration module for universal serial bus of claim 1, wherein the electronic equipment is a personal computer.

9. The integration module for universal serial bus of claim 1, wherein the electronic equipment is a hub.
